(19) United States
(12) Patent Application Publication
(10) Pub. No.: US 2013/0234403 A1
(43) Pub. Date: Sep. 12, 2013

(54) ASSEMBLY FOR SEALING A ROTATIONAL CONNECTION

(71) Applicant: Hermann Willaczek, Hemhofen (DE)

(72) Inventor: Hermann Willaczek, Hemhofen (DE)

(73) Assignee: IMO HOLDING GMBH, Gremsdorf (DE)

(21) Appl. No.: 13/814,276

(22) PCT Filed: Aug. 5, 2011
(86) PCT No.: PCT/EP2011/063572

§ 371 Date: May 16, 2013

(30) Foreign Application Priority Data
Aug. 5, 2010 (DE) 10 2010 034 033.2

(51) Int. Cl. F16J 15/32

(52) U.S. Cl. CPC F16J 15/3236
USPC 277/562

(57) ABSTRACT

Assembly for sealing a rotary joint, comprising first and second annular parts (2) arranged concentrically, one part being rotatably arranged relative to the other, at least one circumferential gap (18) between the first annular part (2) and the second annular part (3); wherein the first annular part (2) comprises a convex curvature (8), and the second annular part (3) comprises a convex curvature (9); a sealing element (4) received in the gap (18) and disposed sealingly against the first and second annular parts (2); the sealing element (4) comprising sealing lip pairs (21), each pair being associated with one convex curvature (8, 9), such that two sealing lips (21) embrace each convex profile curvature (8, 9) sealingly thereagainst; wherein the sealing element (4) exhibits axial symmetry relative to one axis of symmetry (6), and one axis of symmetry is inclined relative to a vertical axis (13); and the convex profile curvatures (8, 9) have points protruding toward the sealing element (4), and the points lie on an axis (12) perpendicular to the axis (6).

The present invention concerns an assembly for sealing a rotary joint.

The seals that are currently available commercially and are in use for sealing rotary joints and slewing drives differ widely in terms of shape and design, even though the use cases often are very similar. A constant goal is to protect the rotary joint or slewing drive reliably against external influences, for example moisture, wind-borne sand, contaminants or dirt, foreign bodies, etc.

A practical sealing assembly must also ensure resistance to the internal pressure of the lubricant in the bearing. The seal should theoretically satisfy the requirements for preventing foreign bodies from getting into the bearing structure of the joint. At the same time, the seal must support the aim of keeping the lubricant inside the bearing or allowing only small and defined quantities of it to escape from the assembly as a whole. It therefore must have a reasonable ability to withstand the internal pressure of the bearing caused by the lubricant. The skilled person refers to a sealing effect of the seal.

It is the current state of the art that the lubricants or lubricating agents used in rotary joints and slewing drives come into contact with the seal material.

It is also the current state of the art that the seals that are available commercially and are in use are vulcanizable and can be made by all the established methods for producing seal geometries from elastic, rubber-like materials, for example FPM, Viton, NBR, ECO, HNBR and the like.

Ordinary seal assemblies according to the state of the art have in common the fact that they are usually either one-part or multi-part, i.e., consisting of at least one sealing component. Very frequently, various annular sealing strips are inserted in the rotary joint or are fastened in one or more plunge cuts or grooves in the solid material of the rotary joint or on the slewing drive, such that fixation occurs. The fixation is brought about in such cases by inserting the elastic seal material into a groove present in the (metallic) solid material of the assembly to be sealed. This groove is often made by chip-producing machining as a result of so-called “plunge-cut turning” during the production of the rotary joint or slewing drive.

It is often seen at present, and it is possible, for a plurality of such grooves or plunge cuts to be present in the overall assembly to be sealed. As a rule, there are at least exactly as many of these grooves as there are elastic sealing strips to be inserted and fixed in the assembly.

The fixation of the sealing strips or sealing profiles in the aforesaid grooves or plunge cuts is normally accomplished, on the one hand, by means of a form lock, since the elastic springs or lips of the sealing strips or sealing profiles that are inserted in the grooves often have a barb-like profile geometry or geometries, and also, on the other hand, by virtue of the fact that when the rotary joint or slewing drive is operated as intended, any deformation forces always act on the seals roughly perpendicular to the insertion axis of said groove, and thus not in the direction in which the profile geometry or geometries of the sealing ring would be pulled out of said groove or plunge cut.

Moreover, said fixation of the sealing assembly in the metallic solid material can usually be cancelled by the application of force. This means that by applying a given pulling force, which must act in the opposite direction from the force applied to insert the seal into the solid material, the practitioner or skilled person can disengage the inserted seal from the metallic assembly (rotary joint or slewing drive).

According to the known state of the art and due primarily to the described circumstance, the sealing profiles used are frequently configured as barb-like on the basis of the previously described profile geometry or geometries, and are characterized overall by very angular profiles. Despite the problems this creates with production and installation, the sealing effect is respectably good, as a rule, so solutions of this kind are currently preferred by those skilled in the art.

To be sure, it is never the case according to the known state of the art that sealing profiles of this kind, whose profile geometry or geometries enable them to be inserted in existing grooves or plunge cuts in the solid material, are completely symmetrical with themselves in both spatial axes, i.e., in both areal directions.

However, it is always the case in the known state of the art that each seal is fixed in the solid material of the rotary joint or slewing drive by the previously described manner of fixation at at least one location, so as not to depart from the fixed position when operated as intended. Despite the problems this creates with production and installation, the sealing effect is respectably good, as a rule, so solutions of this kind are currently preferred by those skilled in the art.

It is often seen at present, and it is possible, for an elastic portion of the described profile geometry or geometries of the sealing assembly to be fixed to the one rotating part of a rotary joint and for another portion of the same sealing assembly to be fixed to the other rotating part of a rotary joint, and for the sealing effect to be created by the interaction of all the sealing components involved in the assembly as a whole (which are, for example, a first elastic seal, an additional high-grade steel band, an additional tension spring band and a second elastic seal, plus any third elastic sealing components that may desired).

For instance, EP 1 920 176 B1, based on DE 10 2005 041720 A1, describes a successful assembly of this kind for sealing a rotating joint in which the sealing assembly consists of a total of, for example, more than four individual components, each of which extends annularly and in which the sealing ring is fixed in the aforesaid manner to one of the rotating parts.

DE 103 093 83 A1, on the other hand, describes, among other things, a sealing assembly for a rotating bearing which by virtue of its sharply asymmetrical geometry achieves a good sealing effect in combination with an additional ring element made from another material. Here again, the sharply asymmetrical geometry of the sealing profile is fixed in the aforesaid manner to one of the rotating parts.

DE 10 2006 053832 A1 is also concerned with the use of an assembly for sealing two mutually rotatable parts, which uses as additional components a spring or a tension spring band, and in which the sealing ring is fixed in the aforesaid manner to one of the rotating parts.

European inventions EP 1 544 485 A1 and EP 1 544 486 A1 also dealt with seals for bearings, particularly for the sealing closure of an intermediate space in a sense similar to that of the present invention, but employing an additional so-called intermediate ring that is in contact with a plurality of seals and separates them geometrically or physically. In addition, in those inventions, the directly mutually rotatable parts cannot be sealed, but rather, an intermediate ring described in the invention is necessary for the sealing effect according to the invention.

Also known are the documents WO 2010/043248 A1 and WO 2010/043574 A1, which disclose a seal for a rolling bearing: there, a seal has an essentially H-shaped cross section and is disposed between an inner ring and an outer ring of a rolling bearing.

Finally, German applications DE 10 2008 025725 A1 and DE 10 2008 027890 A1 also deal with sealing systems which, as noted above, include a number of features of the known prior art. Here again, the in each case sharply asymmetrical geometries of the sealing profiles on at least one of the rotating parts are fixed in the aforesaid manner to at least one rotating part.

From the standpoint of the skilled person or practitioner, the most optimal seals would be ones having a simple and thus not very angular profile geometry or geometries, so that the sealing assembly or the element for effecting sealing can be inserted with the least possible risk of confusion in the assembly to be sealed. Especially optimal are profile geometries (or a profile geometry) that are symmetrical with themselves in both horizontal and lateral extent, since it of no concern to the practitioner whether the seal is installed “laterally flipped” in the overall assembly to be sealed.

The most desirable profile geometry or geometries for such sealing assemblies or elements are those that can be inserted directly between the two rotating parts, which means that both of the directly rotating parts have physical contact with the most optimal sealing assembly or the element. All other prior-art solutions have partially complex and multi-part designs, which increase the work of installation by their multi-part nature or their complexity. Increased work on installation costs time and money in practice, and is therefore disadvantageous.

Also disadvantageous in practice is the fact that a complex and angular sealing profile geometry or geometries is/are more delicate in configuration than a simple, not very angular profile geometry or geometries, and thus are more sensitive to environmental influences during use and can therefore lead to premature defects and thus the failure of the rotary joint or slewing drive to operate as intended. Any premature defects of this kind that may occur also cost time and money in practice, and this is consequently disadvantageous.

Above all, a constant nuisance in the current state of the art is that in order for the seal to be inserted for the direct sealing of two rotating parts, for example as in a rotary joint or a slewing drive, the aforesaid groove or plunge cut must be present in the solid material of the overall assembly (the rotary joint or slewing drive). Additional production operations will always be needed to sink this groove during the ordinarily chip-producing manufacture of the assembly to be sealed. This also costs time and money in practice and is therefore disadvantageous.

Furthermore, it is important to the skilled person or practitioner that in the case of maintenance or repair work on a rotary joint or slewing drive installed in the field, this most optimal seal or sealing assembly or the element be able to be performed [sic] in less time than the prior-art sealing assemblies currently on the market. This would save time and money in maintenance/repair practice, since longer times for maintenance/repair jobs cost money in practice and are therefore disadvantageous.

All of the aforesaid examples of ways to devise assemblies for sealing two mutually rotatable parts serve to document the state of the art and the disadvantages associated with it. Common to these examples is the fact that, as explained in detail above, either they consist of a plurality of components, at least some of which are fixed to at least one of the mutually rotatable parts and thus do not have a symmetrical or simple profile geometry or geometries that might increase the reliability of installation and the service life of the seal in operation, or, although having a simple geometry, they do not permit the direct sealing of the outer and inner rotating parts that might be desired by the skilled person or the practitioner.

In view of these disadvantages, the problem at hand is to devise a sealing assembly that is as optimal as possible or an element for sealing two directly mutually rotatable parts that is more simply configured with respect to its profile geometry or geometries than the systems that have dominated the market heretofore, and which by virtue of this simpler configuration no longer need be separately secured or fixed to one or both of the rotatable parts of the rotary joint or slewing drive, so that the installation or replacement can be manufactured or produced more easily and simply or with less expenditure. A further aim is to select the manufacturing or production process for the production of seals for machinery and plant construction so that it corresponds to the established state of the art and no special production processes or process steps are needed.

All of the aforesaid disadvantages can be minimized particularly by means of the present invention, which has advantages and features that make for substantial improvement. The problems associated with the cited disadvantages are solved by the features listed in claim 1.

A solution to the disadvantageous problems of the conventional prior art can be achieved particularly if the sealing assembly according to the invention or the element for sealing an assembly to be sealed has a geometry such that said element is always able, by itself and without the involvement of other components, to remain in place, integrated in the overall structure, i.e., without dropping out, both while the rotary joint is in operation and during idle periods. A primary object is that the to-be-sealed opening be sealed constantly by the assembly according to the invention.

This can be achieved particularly by an advantageously configuring the so-called retaining tabs of the sealing assembly. These retaining tabs are, in particular, integral, parallel components of the sealing assembly, which revolve annularly about the rotary joint and are constantly in direct contact laterally with the rotating main parts of the rotary joint. Friction can therefore develop during the operation of the rotary joint, but can be kept to a minimum by suitably conventional lubrication. As explained, these retaining tabs are present on each side of the rotary joint. In the conventional sense, these retaining tabs are sealing lips that are guided along or rest against the rotating parts in order to seal the structure. The symmetrical shape makes for good production properties and imparts very good dimensional stability to the sealing assembly according to the invention.

It is through these retaining tabs that the sealing assembly is in physical contact with the respective rotatable main part. The retaining tabs are also the element that is able to deform the most during operation, when radial forces and tolerances occur that may cause the two respective rotatable main parts of the rotary joint to move toward or away from each other. This same mechanism serves to continuously effect a kind of self-centering of the sealing assembly or the element, such that the latter is never dislodged from the overall structure by its own action or by the rotary motion.

This motion and the so-called bearing play can also be absorbed by the geometric configuration of the sealing assembly or the element. In that case, the retaining tabs of the sealing assembly deform, but the deformation is reversible owing to the elastic properties of the seal material. One advantage here is that the seal always deforms on both sides, and thus is not loaded so heavily on one side as the asymmetrical profile geometry or geometries currently on the market. The pressure resistance is higher than that of the prior-art systems on the market heretofore.

If very large bearing play or a large, sudden unroundness additionally occurs during the rotationally directed motion, a rotation [sic], then the bilateral clearances between the (highest) convex profile curvature of each of the rotatable (main) parts and the sealing assembly will be changed due to the movement of the rotatable (main) parts of the rotary joint toward or away from each other.

These clearances are usually partially wetted with lubricant and are located to the right and to the left of the line of symmetry of the sealing assembly or element. Due to the elastic properties of its material, the seal is able to compress (contraction) or unload (relaxation) in response to any movement of the two mutually rotating parts toward or away from each other during operation.

An equally useful axiom according to the teaching of the invention is that the self-centering mechanisms of the sealing assembly or element are maximal particularly if the angle of the at least one axis of symmetry with respect to the absolute vertical is not chosen to be too great or too small. An angle of approximately 30°, for example, has proven very good in practice. Similar angles are conceivable, but the angle should be no greater than the normal to the absolute vertical, i.e. 90°.

The invention has proven itself in particular if, at the very least, the geometry of the sealing assembly always has at least one symmetry in one of its two central areal directions. The sealing assembly can then be installed without problems even if it is laterally reversed, and less elaborate tools are needed for installation. The same is also true of the elimination according to the invention of the fixing nipples that have always been present heretofore in the prior art. These fixing nipples, configured in the form of lips or in a barb shape, protrude like outgrowths from the sealing profile, as part of the profile geometry or geometries of the seals commercially available heretofore, and according to the current state of the art must always be inserted (fixed) in the rotary joint separately during the installation process, in the grooves or plunge cuts provided for them.

This is no longer a necessity with the profile geometry according to the invention, since there is no longer a need for separate fixation to at least one of the rotatable parts of the rotary joint or slewing drive. By virtue of the simplified arrangement in contrast to the current art, without the use of fine or delicate sealing lips, the system can be used both as an inner seal and as an outer seal for rotary joints or slewing drives. This means, in particular, that the sealing effect of the sealing assembly according to the invention seals to both the inside and the outside.

It is also preferable that when seals that will have to be repaired are installed in components in the field, the inventive sealing assembly can be removed or reinserted in a much more time-optimized manner. In particular, the elastic seal material or the seal material need not be pulled on, squeezed, or pressed into place. This considerably increases the reliability of installation compared to the current sealing systems of the known prior art. A further advantage is that the mounted sealing assembly can relax again throughout its periphery once it has been installed.

Since the sealing assembly as a whole is always self-centering, time can be saved in production in cases where the seal has to be inserted into the solid material (usually steel) of the rotary joint or slewing drive. The grooves or plunge cuts heretofore necessary for this purpose are no longer needed. This naturally leads to decreases in the necessary production times. The geometry, particularly the simplicity of the inventive geometry, also makes it possible to use fewer components both for field repairs and for first-time installation. Because the parts to be installed are fewer in number and also easier for the skilled person to deal with, installation times are reduced and opportunities for error minimized.

Since the sealing assembly as a whole is designed so that it never projects in horizontal extent beyond the planar area spanned in space by the outermost top edges of the rotating parts of the overall structure, the novel inventive sealing assembly or element never interferes with the adjacent structure, which usually is not attached until arrival in the field and at the customer's facilities.

Should the teaching of the invention be used as a combined system that is nevertheless considered to come under the concept of unity, as stated heretofore, no grooves or plunge cuts are needed for fixation in the rotary joint or the slewing drive. Any components to be used in addition, such as, for example, a steel band or a spring tension band or a combination of the two, are fixed in the joint in similar fashion to the previous prior art cited at the beginning hereof. The main difference from the previous prior art is that the supporting sealing assemblies that receive that steel band and/or the spring tension band need not themselves be fixed in the rotating parts separately, as explained in detail above.

The inventive sealing assembly or the element for effecting sealing can offer further advantages if the chosen contours are as round as possible and thus not very angular, to lend the solution particular simplicity and robustness. Whereas, as explained and cited above, the prior solutions can be very angular and rather delicate, thus often leading to mechanical load cases of buckling or bending or foldover or any other combination of said load cases, the novel and inventive structural design and geometric configuration of the sealing assembly or the element is subjected basically to strain and compression, as also explained. These two load cases are the very ones which, from a materials engineering standpoint, can be accommodated very well by rubber-like elastic materials without any risk of notable damage, a fact which in turn has a positive effect on the service life and durability of the solution according to the invention.

It has proven advantageous that said “roundings” do not promote the load case of the notch effect. This notch effect also frequently occurs in very angular designs and is undesirable.

Given the preferred cross section, the installation and removal of the seal solution according to the invention is much simpler and less complex than the currently accepted solutions of prior art.

In another configuration of the invention, sealing lips associated with the first annular main part and particularly disposed adjacent a clearance have a static friction coefficient and/or a kinetic friction coefficient that is different from the static friction coefficient and/or the kinetic friction coefficient of the sealing lips associated with the second annular main part, and/or the contact surfaces of the first annular main part that are associated with the sealing lips have a static friction coefficient and/or a kinetic friction coefficient that is different from the static friction coefficient and/or the kinetic friction coefficient of the contact surfaces of the second annular main part that are associated with the sealing lips.

The sealing profile can be coated or greased on only one side before being installed in a rotary joint, such that the sealing profile is coated or greased on only one side and thus during operation is virtually fixed to the one main part and has good slidability against the other main part.

Additional features, characteristics, advantages and effects based on the invention will become apparent from the following descriptions of a preferred embodiment of the invention and other advantageous configurations of the invention, and by reference to the drawings. Therein:

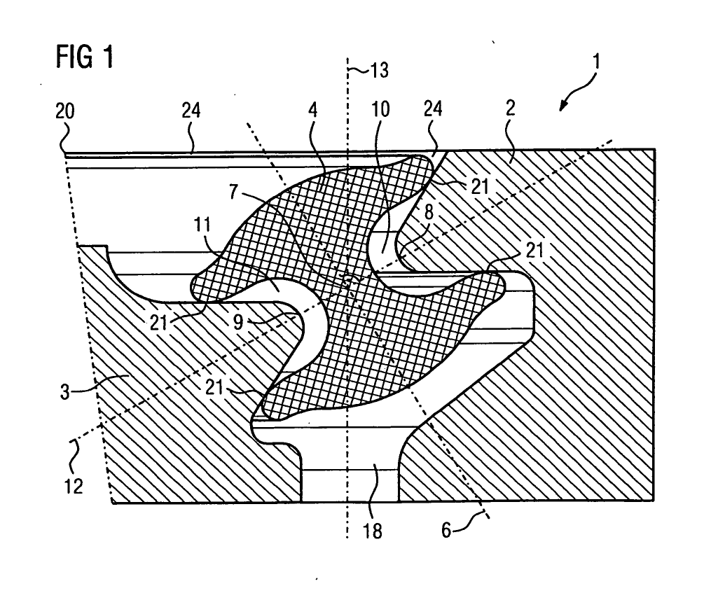

FIG. 1 shows a first view of the sectional geometry of a one-part embodiment of this sealing assembly or element (4), looking at the cross-sectioned surface of a sectioned segment; this is a section through a rotary joint (1) that can be used as rolling elements, balls or rollers or sliding components, or a hybrid form of all of the foregoing.

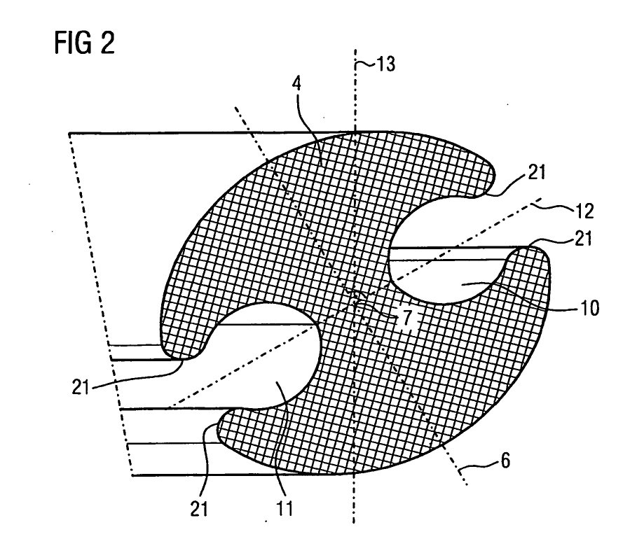

FIG. 2 shows another exemplary embodiment of this sectional geometry of this one-part embodiment of this sealing assembly or element (4), in which the contours of the seal have been changed slightly in comparison to FIG. 1.

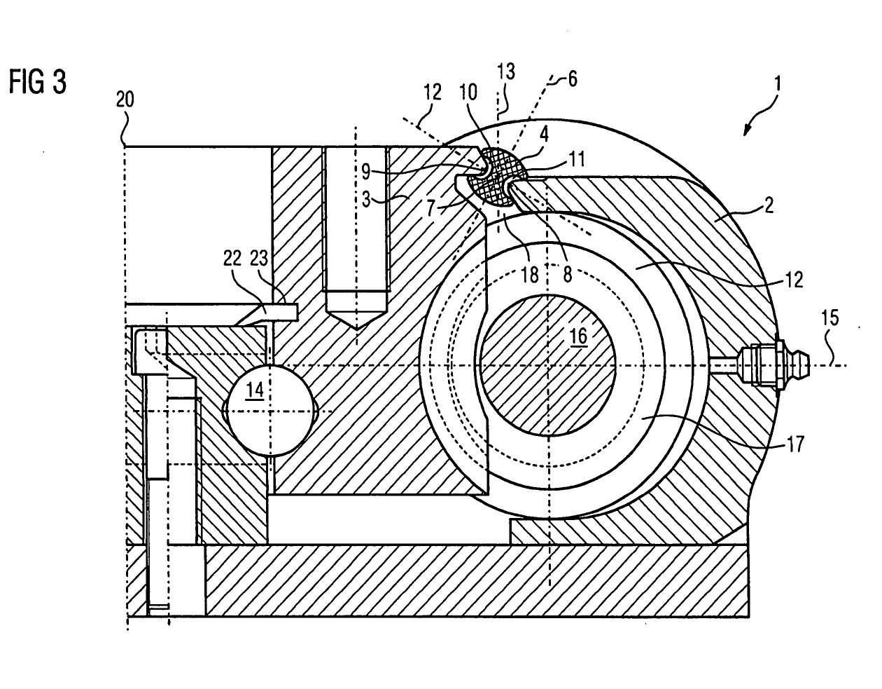

FIG. 3 is another view of the sectional geometry of a one-part embodiment of this sealing assembly or element, looking at the cross-sectioned surface of a sectioned segment; this is a section through a slewing drive, which for purposes of the rotational adjustment of the outer ring of a rotary joint on a rotary joint comprising balls as rolling elements [sic]. Also shown for purposes of comparison in this FIG. 3 is an exemplary conventional sealing element (22) that is fixed by means of fixing nipples in one of the above-mentioned conventional grooves or plunge cuts (23) according to the state of the art.

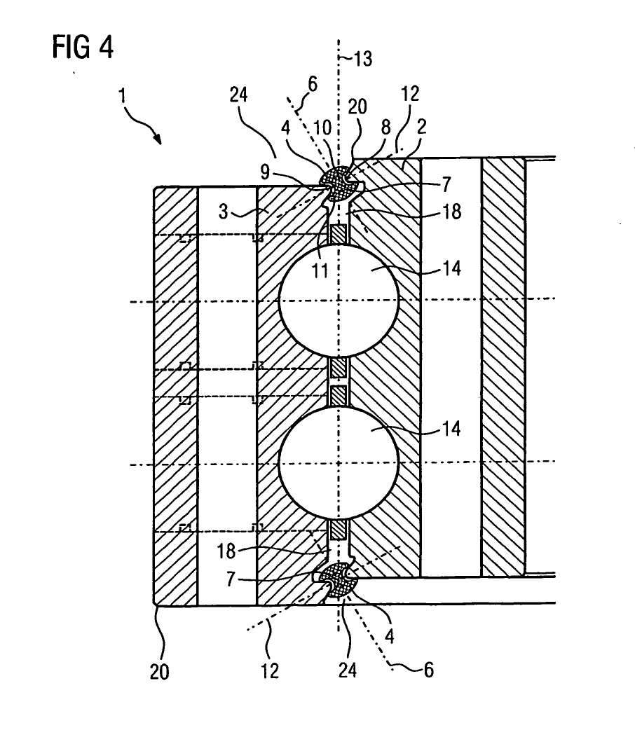

FIG. 4, on the other hand, does not show a slewing drive, but instead depicts the invention implemented as a one-part element that is installed directly between the inner ring and the outer ring of a rotary joint without the need to fix the sealing assembly or the element in a groove or plunge cut. No such prior-art or conventional fixation is needed, neither to the inner ring nor to the outer ring.

In all the figures, FIGS. 1 through 4, it is apparent that the sealing assembly or element (4), which is a sealing element, is fixed neither to the one of the directly mutually rotatable parts, namely a first rotatable main part (3), nor to the other of the directly mutually rotatable parts, a second rotatable main part (2). Depending on the design of the rotary joint or the slewing drive, the first or the second main part (2), (3) can also be stationary, for example disposed on a machine bed or system bed. The sealing element (4) is so arranged between the first rotatable main part (2) and the second rotatable main part (3) as to permit relative movement between the sealing element (4) and the first and second rotatable main parts (2, 3). Hence, relative movements occur between the first and second rotatable main parts (2, 3) and the sealing element (4) during the operation of the rotary joint or slewing drive (1).

In practice, the adjacent structures attached to a bearing or slewing drive and connected above the outermost top edges of all the rotating parts can cause substantial deformation, ranging up to several millimeters, in the bearing between the inner ring, for example (2), and the outer ring, for example (3). One of the essential advantages of the invention is that the deformation distributes itself into approximately equal loads on both sides of the retaining tabs or on both sides of the pairs of lips. One advantage of this is that, in practice, twice the deformation can be accommodated by sides of the sealing assembly or the element (4). The sealing element (4) has a symmetrical cross section, specifically an axially symmetrical cross section with an axis of symmetry (6) or line of symmetry, which line of symmetry (6) extends through a seal center (7). At the same time, the cross section of the sealing element (4) also has axial symmetry with respect to a normal (12) to the line of symmetry. A normal (12) to the line of symmetry and an absolute vertical (13) intersect at the seal center. Furthermore, each sealing element (4) has four sealing lips (21) or retaining tabs, two of which rest, preferably areally, against the first rotatable main part (2) and two against the second rotatable main part (3). Formed between the sealing lips (21) resting against the first rotatable main part is an upper clearance (10), or, alternatively, a recess, which is provided between a convex profile curvature of the first rotatable main part and the sealing assembly or the sealing element (4). In keeping with the axial symmetry, a lower clearance, or a recess, is also provided between the two mutually confronting sealing lips (21) resting against the second rotatable main part (3), between a convex profile curvature of the first rotatable main part and the sealing assembly or sealing element (4). The first rotatable main part (2) has an upper, rounded convex profile curvature (8) in the shape of a triangle with a rounded apex. Likewise, the second rotatable main part (3) has an upper, rounded convex profile curvature (9) in the shape of a triangle with a rounded apex. The convex profile curvatures (8), (9) are arranged on the main parts (2), (3) in such a way that the points of the convex profile curvatures (8), (9) that protrude farthest in the direction of the sealing element (4) lie on the normals (12) to the line of symmetry. In this way, the convex profile curvatures (8) (9) are opposite each other during the operation of the rotary joint or the slewing drive (1), thus limiting the passage that must be sealed by the profile element (4).

Despite the possibility that the sealing assembly or the element will deform as a result of the rotationally directed operation of the rotary joint or the slewing drive (1), there is, naturally, no substantial change in the nominal radius or the diameter of the sealing assembly, meaning here the distance between the seal center (7) and the center of the circle described by the rotary motion of the rotation (of the slewing drive or the rotary joint). This means that any changes in the radius or diameter of the sealing assembly occur only as a result of the elastic properties and/or temperature influences and/or the radial and axial deformation in the bearing. By way of example, FIG. 2 shows a sealing element (4) with a modified cross section compared to that of the sealing element (4) depicted in FIG. 1. The cross section has a round contour and the sealing lips forming the clearances (10), (11) are undercut, or in other words are a distance apart such that the clearances have a nearly closed concave shape.

In all the cited figures, the elastic seal material is always a, for example, rubber-like material that is vulcanizable and can be used in common with all established substances used in mechanical engineering to lubricate rotary joints. FIG. 3 is a section through a slewing drive that is equipped with a rotary joint to effect rotational adjustment of the outer ring. The rotary joint comprises rolling elements (14). A first main part (2) is stationarily disposed and is in operational connection with a second rotatable main part (3). The second rotatable main part (3) is connected by rolling elements (14) to a rotary joint, the example shown being that of a conventional sealing element (22), fixed in a groove or a plunge cut (23) by means of fixing nipples. The first main part (2) and the second rotatable main part (3) are so arranged relative to each other that between the two main parts there is an opening (18) to be sealed, whose maximum through-passage area is defined by the distance between the convex profile curvature (8) of the first main part and the convex profile curvature (9) of the second main part. The sealing element (4) is arranged between the two convex profile curvatures (8), (9) in such a way that the convex profile curvatures (8), (9) are received each in the respective associated clearance (10), (11) or recess. The drive train of the slewing drive (1) is implemented by means of a shaft (16) surrounded by a toothed wheel (17), by means of which the second rotatable main part (3) can be moved in rotation. The lubrication of the slewing drive (1) takes place via a lubricating nipple (15). The sealing element (4) seals the drive train of the slewing drive with respect to the environment.

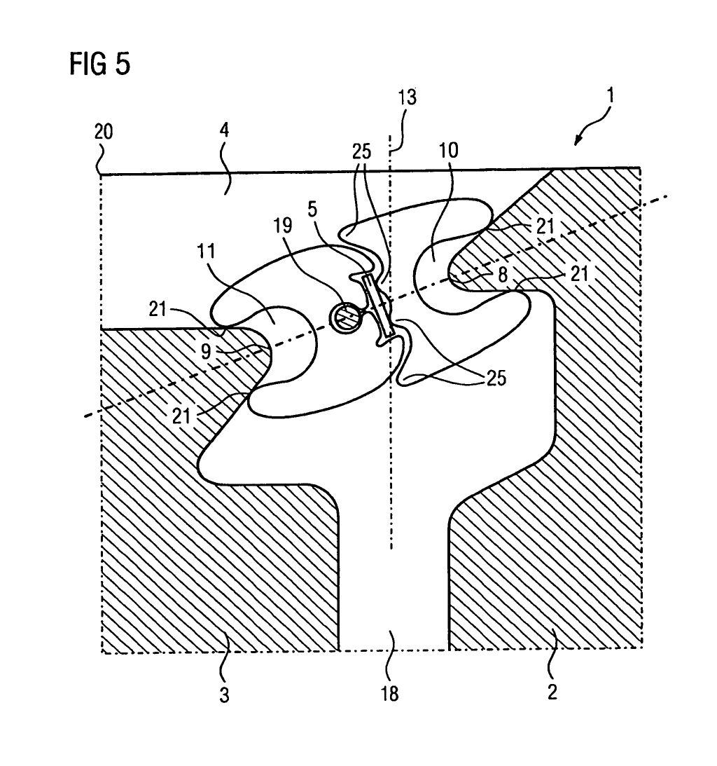

FIG. 5 shows for the first time a multi-part version of the sealing assembly, which is composed of a plurality of sealing rings having one or more additional sealing lips (25). It should be noted that these additional sealing lips (25) are not the same components as the retaining tabs (21) cited above, since they do not have the function of resting against the convex profile curvatures of the directly rotating parts. They instead rest against other sealing lips (25).

In the case of the multi-part design—referring now to the sealing assembly according to the invention and FIG. 5—it can be that at least one lip of a sealing ring has a closed band (5) made of another material resting against it and running all along its circumference. The band can consist, for example, of high-grade steel or another metal material. Optionally, a tension spring arrangement (19) can also be disposed in the sealing assembly to lend additional stability in the radial direction to the sealing assembly as a whole. The sealing element (4) is constructed as follows. The sealing element (4) comprises four sealing lips (21), whose arrangement is based on the symmetry scheme described above. The sealing element (4) is disposed in a to-be-sealed opening (18), specifically in such a way that the convex profile curvature of the first main part (2) is received in a clearance (10) and the convex profile curvature of the second main part (3) is received in a clearance (11). The cross section of the profile of the sealing element (4) is two-part and comprises, on a profile portion that faces the convex profile curvature (8) of the first part, additional, particularly four, sealing lips (25), which are in contact with the profile portion that faces the convex profile curvature (9) of the second part. The two parts of the sealing element are installed one after the other in a mounting operation; the closed band (5) and/or the tension spring arrangement can be disposed, premounted, on one of the parts of the sealing element (4).

Returning now to the one-part embodiment: Here, the sealing assembly or element (4) operative to seal two directly mutually rotatable parts (3) (2) and embodied as a revolving ring is consists of [sic] an elastic seal material. FIG. 4 clearly illustrates one of the essential features of the invention, namely that in the invention no form lock or force lock, and thus no grooves or plunge cuts, are necessary between the sealing assembly and the directly mutually rotating parts in order to locally fix the sealing ring. The symmetrical geometry with which the sealing assembly is further provided ensures easy and twist-proof installation and rapid replaceability.

It can also be seen from the example of FIG. 4, which is a view of the cross-sectioned surface of a sectioned segment of this rotary joint or slewing drive, that the sealing assembly has complete symmetry with itself in at least one of the two surface directions. It is also clearly apparent that the line of symmetry (6) in the direction of the verticals (13) is inclined less than 90° to the verticals (13). It has proven particularly advantageous in practice if the angle is approximately 30°. It should always be kept in mind, according to the invention, that the angle selected should be whatever seems to the most reasonable from the standpoint of the adjacent structure, in view of the following. The direction in which the two convex profile curvatures, meaning those clasped or surrounded by the retaining tabs or sealing lips, move toward each other usually points through the geometric center (7) of the sealing element or the sealing assembly. However, whether the direction of this movement actually points through the center (7) or whether this center (7) merely serves as the instantaneous center of a rotational movement resulting from the relative movement of the two rotating parts (2) and (3) depends greatly on the bearing design used and also on the adjacent structures connected to the left and right of the rotary joint as a whole.

This adjacent structure is usually connected by means of screws. It is also worth noting that in practice, depending greatly on the use case of the rotary joint or slewing drive, the deformation of the elastic sealing element (4) is not always due half to radially acting forces and half to axially acting forces. In point of fact, the forces acting on (4) can sometimes be predominantly axial and sometimes predominantly radial.

The actual force distribution depends on the bearing design, and the angle at which the seal is inclined to the vertical is selected accordingly. In many cases this angle is about 30°, owing to the bearing design and the radial or axial forces that must be accommodated, but all other angles between 0° and 90° are certainly conceivable and reasonable in the sense of the invention.

Another design and conformation feature of the invention can be seen plainly in FIG. 1, and particularly also in FIG. 3. The invention provides that the sealing assembly or the element (4) is designed and geometrically shaped in such a way that it never catches on or touches the structure adjacent to the rotary joint (or to the slewing drive). It is also readily apparent from the figures that an unoccupied gap or, viewed three-dimensionallly, an unoccupied circular area (24), always remains between the highest top edge (20) of the outermost rotating part and all of the rotating parts beneath it. This is the case, for example, on both sides of a rotary joint. This unoccupied geometry (or geometries) ensures that the sealing element according to the invention or the sealing assembly according to the invention does not drag against and additionally brake any adjacent structure and thus become abraded.

Let us now also consider FIG. 1 by way of example. The following symmetry considerations furnish a very good further explanation of the main point of the present invention: The sealing assembly or element has at least one line of symmetry (6) in the direction of the verticals (13) and an imaginary normal (12) thereto; this normal (12) intersects the line of symmetry of the verticals (13) at the seal center (7) and, in approximately the direction of said normal (12), convex profile curvatures (8) (9), each triangular and rounded at the apex of the triangle and belonging to a respective one of the two mutually rotatable parts (3) (2), penetrate in the direction of the seal center (7). During the operation as intended of the rotary joint or the slewing drive (1), the sealing assembly or the inventive element can become significantly deformed. According to the invention, rounded clearances on both sides of the convex profile curvatures (8) (9) between the seal material and the respective convex profile curvature ideally remain exactly round (10) (11), for example, and permit this penetrating movement, and the triangular convex profile curvatures tangentially conform to the respective ends of these rounded clearances.

The inventive principle of self-centering is readily apparent in all the drawings presented below (FIGS. 1 through 5). By virtue of the fact that the forces either in the radial direction and/or in the axial direction are absorbed by the inventive device (4) and all of these forces act approximately in the direction of the seal center (7), the seal is centered automatically when any rotational movement of the rotary joint or the slewing drive (1) occurs.

### LIST OF REFERENCE NUMERALS

1 Rotary joint
2 First annular main part
3 Second annular main part
4 Sealing element
5 Closed circumferential band
6 Axis of symmetry
7 Geometric center
8, 9 Convex profile curvatures
10, 11 Clearances
12 Axis
13 Vertical axis
14 Rolling element
15 Lubricating nipple
16 Shaft
17 Toothed wheel
18 Gap
19 Tension spring arrangement
20 Top edge
21 Sealing lips
22 Sealing element
23 Plunge cut
24 Area
25 Sealing lips

1. An assembly for sealing a rotary joint, the assembly comprising
at least one first annular main part (2) and at least one second annular main part (3) arranged concentrically about a common axis, wherein at least one annular main part is rotatably arranged relative to at least one other annular main part, and wherein at least one circumferential gap (18) is provided between the at least one first annular main part (2) and the at least one second annular main part (3);
wherein the first annular main part (2) comprises at least one convex profile curvature (8) projecting in a direction of the second annular main part (3), and wherein the second annular main part (3) comprises at least one convex profile curvature (9) projecting in a direction of the first annular main part (2);
at least one sealing element (4) received in the circumferential gap (18) and which rests sealingly against the first annular main part (2) and the second annular main part (3);
wherein said sealing element (4) comprises at least four sealing lips (21) arranged in pairs, and wherein each pair of sealing lips (21) is associated with a respective one of the convex profile curvatures (8, 9), such that two sealing lips (21) embrace each convex profile curvature (8, 9) and rest sealingly thereagainst;
wherein said sealing element (4) exhibits axial symmetry with respect to at least one axis of symmetry (6), and wherein the at least one axis of symmetry (6) is inclined relative to a vertical axis (13) and/or a horizontal axis; and
wherein the convex profile curvatures (8, 9) are provided with points that protrude farthest in the direction of the sealing element (4) and wherein said points lie generally on an axis (12) perpendicular to the axis of symmetry (6).

2. The assembly for sealing a rotary joint in accordance with claim 1, wherein the circumferential gap (18) comprises a bearing play, during a rotational movement of the first annular main part (2) relative to the second annular main part (3), and/or a rotational movement of the second annular main part (3) relative to the first annular main part (2), wherein the sealing element (4) is deformable such that the sealing element rests sealingly against the first and second annular main parts (2), (3) when the size of the circumferential gap (18) is increased and/or decreased as a result of the play.

3. The assembly for sealing a rotary joint as set forth in claim 1, wherein the sealing element (4) comprises a rubber material, is vulcanizable, and can be used in common with all lubricants used to lubricate rotary joints.

4. The assembly for sealing a rotary joint as set forth in claim 1, wherein the second annular main part (3) is surrounded by the first annular main part (2), wherein the sealing element (4) is configured as a two-part element, wherein at least one part of the sealing element (4) rests sealingly against the second annular main part (3), wherein at least the part of the sealing element (4) which rests sealingly against the second annular main part (3) comprises a closed band (5) and/or a tension spring arrangement, such that the sealing element (4) that rests against the second annular main part (3) is pressed at least partially against the second annular main part (3).

5. The assembly for sealing a rotary joint as set forth in claim 1, wherein the sealing element (4) is provided with axial symmetry with respect to at least one axis of symmetry (6), and wherein the at least one axis of symmetry (6) is inclined less than 90° relative to the vertical axis (13).

6. The assembly for sealing a rotary joint as set forth in claim 1, wherein the sealing element is disposed below an outermost top edge of said annular main parts (2), (3).

7. The assembly for sealing a rotary joint as set forth in claim 1, wherein the sealing element (4) is self-centering, within said circumferential gap (18) and/or relative to the first and/or second annular main part (2), (3), upon rotational movement of the first annular main part (2) relative to the second annular main part (3), and/or rotational movement of the second annular main part (3) relative to the first annular main part (2).

8. The assembly for sealing a rotary joint as set forth in claim 1, wherein the rotary joint includes a slewing drive, said first annular main part (2) is stationarily disposed, and is in operational connection with, the second annular main part (3) and a drive train of the slewing drive comprises a shaft (16) comprising a toothed wheel (17) via which the second annular main part (3) can be moved in rotation.

9. The assembly for sealing a rotary joint as set forth in claim 1, wherein sealing lips (21) associated with the first annular main part (2), adjacent to a clearance (10), (11), exhibit a static friction coefficient, and/or a kinetic friction coefficient different from the static friction coefficient, and/or the kinetic friction coefficient of the sealing lips (21) associated with the second annular main part (3), and/or the contact surfaces of said first annular main part (2) associated with the sealing lips (21) exhibit a static friction coefficient and/or a kinetic friction coefficient different from the static friction coefficient and/or the kinetic friction coefficient of the contact surfaces of the second annular main part (3) associated with the sealing lips (21).

10. The assembly for sealing a rotary joint as set forth in claim 9, wherein the sealing lips (21) associated with the first annular main part (2), or the sealing lips (21) associated with the second annular main part (3), and/or the contact surfaces of the first annular main part (2) associated with the sealing lips (21), or the contact surfaces of the second annular main part (3) associated with the sealing lips (21), are provided with a partial powder coating, and/or a grease filling, and/or a lacquer coating.
